(19) United States
(12) Patent Application Publication
(10) Pub. No.: US 2010/0187955 A1
(43) Pub. Date: Jul. 29, 2010

(54) Wheel-based propulsion system for vehicles

(76) Inventor: Jerome Andrew Steers, Miami, FL (US)

Correspondence Address: MALLOY & MALLOY, P.A., 2800 S.W. Third Avenue, Historic Coral Way, Miami, FL, 33129, US

(21) Appl. No.: 12/657,664

(22) Filed: Jan. 25, 2010

Related U.S. Application Data
(63) Continuation of application No. 11/544,267, filed on Oct. 6, 2006, now abandoned.
Application No. 11/544,267 is a continuation-in-part of application No. 11/054,100, filed on Feb. 10, 2005, now abandoned.

(51) Int. Cl. B60K 1/00; H02K 7/14

(52) U.S. Cl. 310/67 R

(57) ABSTRACT

A wheel-based propulsion system for a vehicle that includes a stator device and a reaction device disposed on the wheel components of a vehicle. The stator device is structured to generate an electric and/or magnetic field that causes the reaction device to rotate and/or move relative thereto and about an axis of the wheel. The reaction device is securely attached to a rotating wheel-based component in order to impart its rotation thereto and thereby at least partially propel the wheel and therefore the vehicle.

### CLAIM OF PRIORITY

The present application is a continuation of previously filed, now pending application having Ser. No. 11/544,267, filed on Oct. 6, 2006, which is a continuation-in-part application of previously filed, now abandoned application having Ser. No. 11/054,100, filed on Feb. 10, 2005, which are incorporated herein in their entirety by reference.

### BACKGROUND OF THE INVENTION

1. Field of the Invention

This invention relates to a wheel-based propulsion system for vehicles that is secured to at least one wheel and at least one caliper housing of the vehicle and through the generation of electric and/or magnetic fields results in aided rotation of the wheel in order to achieve at least partial propulsion of the wheel and therefore the vehicle. The present propulsion system, by aiding the rotation of a wheel at which it is installed, reduces the engine load, and thus the engine wear and fuel consumption required to propel the vehicle, while also maintaining significant efficiency, ease of use, and ease of installation, by its ability to be used as an auxiliary propulsion source that does not need to bear the entire brunt of the vehicle propulsion requirements. Such ease of installation is demonstrated, for example, by its ability to be attached or installed on a vehicle without the need to modify or re-engineer the vehicle, such as by retrofitting. Since the present invention may be removably attached, it may therefore also be portable, providing an example of its ease of use.

2. Description of the Related Art

Individuals all over the world use automotive vehicles as transportation everyday, whether it be a car, truck, bus, moped, or any other vehicle. Additionally, most of the vehicles utilized everyday include a variation of an internal combustion engine or other propulsion system that uses gasoline. Further, as the price of gasoline continues to dramatically increase, the demand for a fuel efficient vehicle rises.

Additionally, a common complaint over the current array of vehicles used today is the immense amount of pollution that is dispersed throughout the environment. Each vehicle equipped with an internal combustion engine creates an intolerable amount of pollution throughout the environment.

At the same time, however, many of today's drivers do not want to sacrifice power and/or speed for a more fuel efficient vehicle or for a vehicle that emits less pollution.

As such, there is a current need in the art of transportation for a vehicle propulsion system that will improve fuel economy and power, while at the same time decreasing pollution that is emitted into the environment. Such a vehicle propulsion system could be embedded and/or disposed within the wheel-based components of the vehicle so as to eliminate the need to reconfigure complex engine components, and may operate on electric and/or magnetic fields rather than gasoline, thus reducing air pollution while at the same time providing the vehicle with the desired amount of power and speed.

Further, it would be beneficial to have a wheel-based propulsion system for a vehicle that works in conjunction with a typical internal combustion engine, thereby providing the vehicle with extra power and/or fuel economy than normally or typically available. Additionally, the propulsion system should automatically provide the vehicle with extra power when needed, such as when negotiating a steep hill, or passing a car or truck on the highway, and/or can be configured to permit the driver or operator of the vehicle to utilize the extra power when desired.

Additionally, it would be beneficial if the proposed wheel-based propulsion system for a vehicle was able to provide one hundred percent of the power desired and/or needed to propel the vehicle, thus eliminating the drawbacks of the internal combustion engine all together. This would increase reliability of the vehicle, improve fuel economy, save energy, and reduce air pollution.

### SUMMARY OF THE INVENTION

The present invention is directed to a wheel-based propulsion system for a vehicle. More in particular, the wheel-based propulsion system for a vehicle of the present invention may include at least one stator device and at least one reaction device, with the reaction device being disposed in a proximate relation to the stator device. Further, the wheel-based propulsion system for a vehicle of the present invention may be disposed within the wheel-based components of a vehicle, including, but not limited to, the caliper housing, the wheel or rim, the axle, the tire, or any other wheel-based component of a vehicle, or any combination thereof so as to provide direct propulsion force at the wheel(s) of the vehicle.

The stator device and possibly the reaction device of at least some embodiments of the present invention may be any device or combination of devices that is structured to generate an electric and/or magnetic field. Further, the stator device and/or reaction device of at least some embodiments of the present invention may be structured to include circuitry and/or any arrangement of wires, chips, logic gates, or any other structure designed or intended to generate the desired field.

In at least one embodiment of the present invention the stator device may be disposed in supporting relation to a caliper housing of the vehicle, such as on or within the caliper housing, using any temporary or permanent attachment techniques. Furthermore, the reaction device may be disposed rather close to the stator device, such as the spacing between the caliper housing of a vehicle and the disc brake member or the wheel or rim member of a vehicle. In that manner, the stator field and the reaction field being generated may be disposed in interactive relation with one another such that the two fields at least partially overlap each other.

The reaction device of the present invention may be at least partially attached to at least one disc brake member of a vehicle. The reaction device may be attached to the disc brake member utilizing any permanent or temporary technique such that if the reaction device moves and/or rotates, the respective disc brake member moves and/or rotates as well.

The reaction device of the present invention may be at least partially attached to at least one wheel or rim member of a vehicle, such as utilizing any permanent or temporary technique, including removable attachment, such that if the reaction device of the present invention moves and/or rotates, the respective wheel or rim member to which the reaction member is attached moves and/or rotates as well. As such, movement or rotation of the reaction device as a result of the interactive relation between the stator field and the reaction field at least partially generates movement or rotation of the member of the vehicle to which the reaction device of the present invention is attached, thus causing propulsion of the vehicle.

Further, the wheel-based propulsion system for a vehicle may include a sensor mechanism attached and/or disposed in communicative relation to either the stator device or the reaction device, or both. Additionally, the sensor mechanism may also be disposed in communicative relation with an acceleration pedal or any other button and/or switch disposed on or within the vehicle so as to properly regulate operation of the present invention as desired. In this regard, the sensor mechanism may be structured to be operative and/or activated/deactivated in a plurality of situations, including, but not limited to, when the driver or operator of the vehicle compresses/decompresses the acceleration pedal or any other activating/deactivating button or switch, or when the vehicle is in need of more/less power. As such, the sensor mechanism of the present invention may be structured to increase, decrease, or maintain the electric field generated or induced by the stator device or the reaction device of the present invention. More in particular, as the stator fields and/or reaction fields are increased or decreased, the rotational speed or movement of the wheel-based propulsion system of the present invention may increase or decrease, respectively.

These and other features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of one preferred embodiment of the wheel-based propulsion system for vehicles of the present invention;

FIG. 2 is a schematic representation of another preferred embodiment of the wheel-based propulsion system for vehicles of the present invention; and

FIG. 3 is a schematic representation of another preferred embodiment of the wheel-based propulsion system for vehicles of the present invention.

Like reference numerals refer to like parts throughout the several views of the drawings.

### DETAILED DESCRIPTION OF THE PREFERRED EMBODIMENT

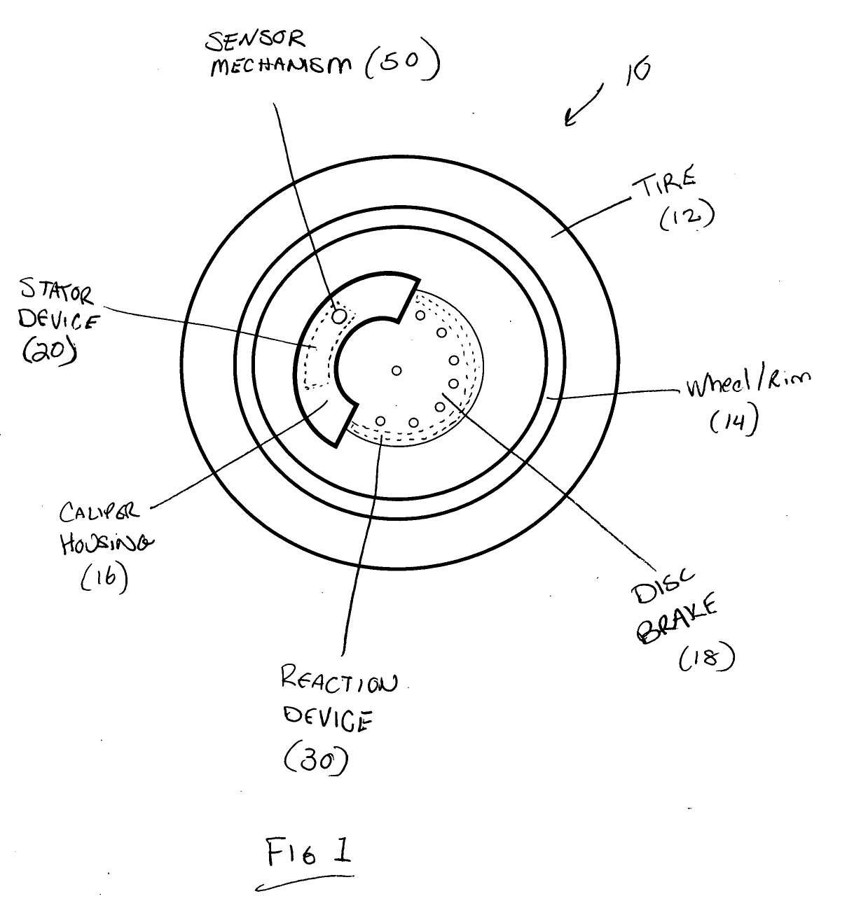

As shown in the accompanying drawings, the present invention is directed to a wheel-based propulsion system for vehicles, generally indicated as 10 and shown in detail in FIGS. 1 through 3. More specifically, the wheel-based propulsion system of the present invention includes a stator device 20 and at least one reaction device 30, wherein the reaction device 30 is disposed in a proximate relation to the stator device 20. Further, both the stator device 20 and the reaction device 30 of the present invention may be disposed in the wheel-based components of a vehicle.

The stator device 20 of the wheel-based propulsion system 10 of the present invention may be any device structured to generate an electric and/or magnetic field. The electric and/or magnetic field generated by the stator device 20 of the present invention may be referred to hereinafter as a stator field. The stator device 20 may include any circuitry and/or any arrangement of wires, chips, logic gates, or any other structure designed and/or intended to generate an electric and/or magnetic field. Additionally, the stator device 20 may include a permanent and/or electro-magnet.

Furthermore, as shown in FIG. 1, in at least one preferred embodiment of the wheel-based propulsion system 10 of the present invention, the at least one stator device 20 may be disposed in a supported relation on a caliper housing 16 of the wheel-based components of a vehicle. More specifically, the stator device 20 may be securely attached to the caliper housing 16 using any generally known method, including, but not limited to, adhesion, and may be used, for example, to retrofit an existing vehicle. Additionally, the stator device 20 may be permanently or temporarily embedded within the caliper housing 16 of the present invention. The stator device 20 may further be removably attached to the caliper housing 16, rendering the system 10 portable. Moreover, the attachment of the stator device 20 to the wheel-based component of the vehicle, such as to the caliper housing 16, whether permanent or temporary, may be accomplished without modification to or re-engineering of the existing vehicle.

In at least one preferred embodiment of the present invention, the reaction device 30 of the present invention may be disposed in proximate relation to the stator device 20. More in particular, the reaction device 30 of the present invention may be disposed in close proximity to the stator device 20 such that the electric and/or magnetic field generated by the stator device 20 may interact with an electric and/or magnetic field of the reaction device 30, explained and described in more detail below.

The reaction device 30 in at least one preferred embodiment of the present invention may be structured to generate its own electric and/or magnetic field. Additionally, in another preferred embodiment of the present invention, the reaction device 30 may be structured such that the stator field, or the electric and/or magnetic field generated by the stator device 20, induces and/or creates an electric and/or magnetic field in the reaction device 30. The field either generated by the reaction device 30 or induced by the stator field may be referred to hereinafter as the reaction field. Furthermore, the reaction device 30 may be structured to include any circuitry and/or any arrangement of wires, chips, logic gates, or any other structure designed or intended to either generate an electric and/or magnetic field or to have an electric and/or magnetic field induced. Further, the reaction device 30 of the present invention may include any permanent or electro-magnet.

In at least one preferred embodiment of the present invention, the electric and/or magnetic field generated by the stator device 20 and the electric and/or magnetic field generated by the reaction device 30 may be disposed in an interactive relation. More specifically, the stator field and the reaction field may be disposed to cause interaction between the two electric fields, such that they at least partially overlap. Further, the interactive relation between the stator field and the reaction field may cause the reaction device 30 of the present invention to at least partially rotate and/or generate movement.

As shown in FIG. 1, in at least one preferred embodiment of the present invention, the reaction device 30 of the wheel-based propulsion system 10 may be at least partially attached to a disc brake member 18 of a vehicle. More specifically, the reaction device 30 may be attached to the disc brake member 18 in any manner to facilitate movement or rotation of the disc brake member 18 in relation to any rotation or movement of the reaction device 30 of the present invention. For example, the reaction device 30 may be securely attached to the disc brake member 18 by utilizing adhesive material and/or screws or bolts, such as when attaching to an existing vehicle. The reaction device 30 may also be removably attached to the disc brake member 18. Further, the reaction device 30 of the present invention may be embedded and/or manufactured within the disc brake member 18.

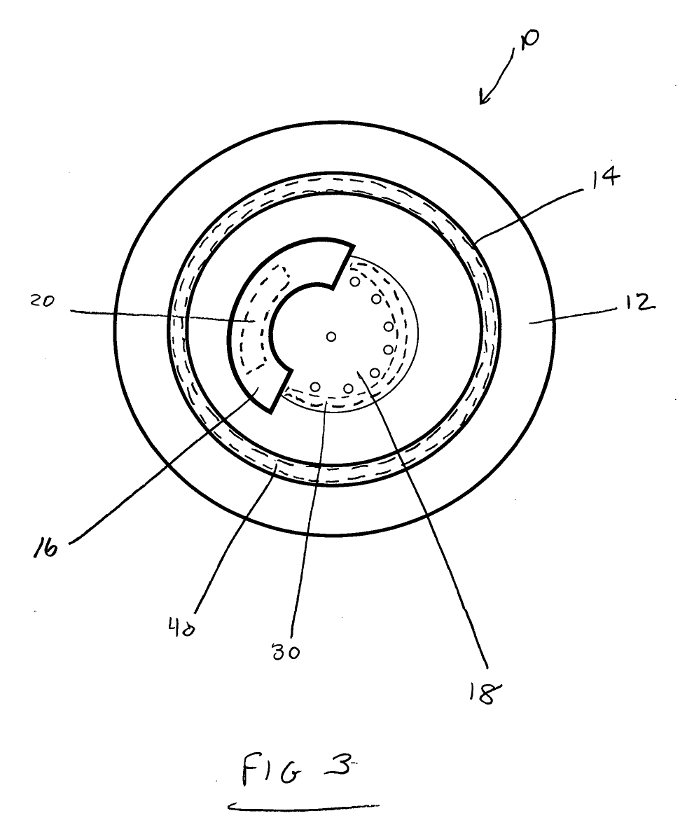

At least one preferred embodiment of the present invention, as shown in FIG. 3, comprises at least two reaction devices 30 and 40 which may be at least partially attached to more than one wheel-based member of the vehicle. For example, at least one reaction device 30 may be at least partially attached to the disc brake member 18 and at least one reaction device 40 may be at least partially attached to the wheel or rim member 14 of the vehicle. In this embodiment, both reaction devices 30, 40 either have a generated reaction field or an induced reaction field which interacts with the stator field. The inclusion of additional reaction devices 30, 40 may increase efficiency and/or economy of the wheel-based propulsion system for a vehicle 10 of the present invention.

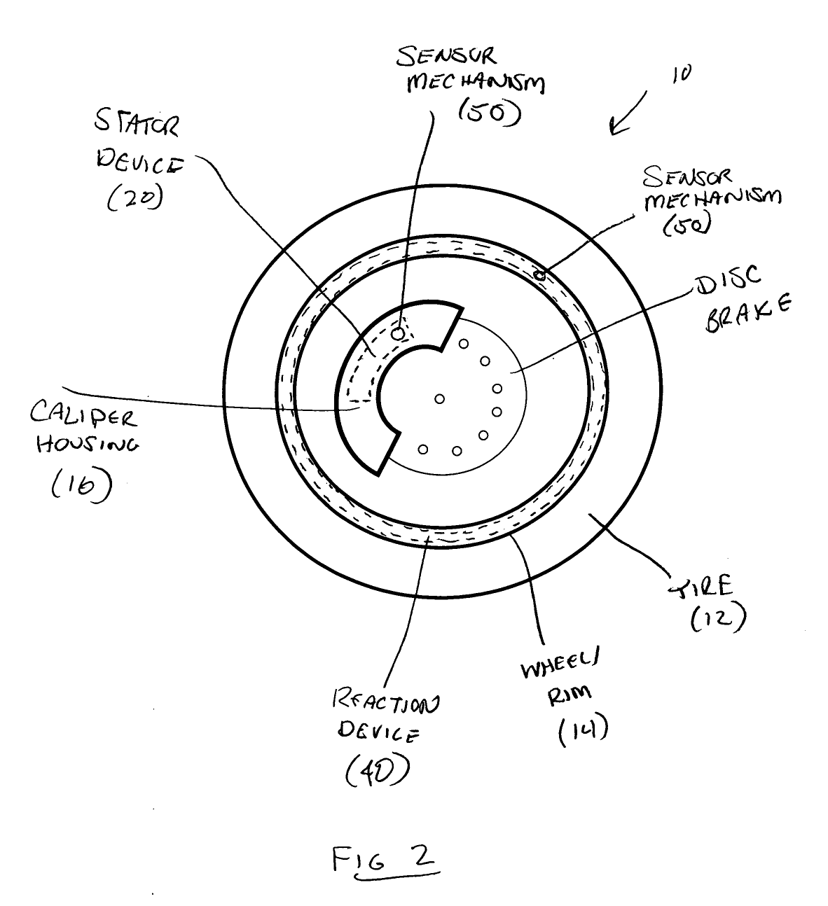

Additionally, as shown in FIG. 2, in at least one preferred embodiment of the present invention, the reaction device 40 of the wheel-based propulsion system 10 may be at least partially attached to the wheel or rim member 14 of a vehicle. More specifically, the reaction device 40 may be attached to a wheel or rim 14 in any manner to facilitate movement or rotation of the wheel or rim 14 in relation to any rotation or movement of the reaction device 40 of the present invention. For example, the reaction device 40 may be securely attached to the wheel or rim member 14 by utilizing adhesive material and/or screws or bolts. The reaction device 40 may also be removably attached to the wheel or rim member 14. Further, the reaction member 40 of the present invention may be embedded and/or manufactured within the wheel or rim member 14.

As such, movement or rotation of the reaction members 30 and/or 40 of the present invention at least partially as a result of the interactive relation between the electric and/or magnetic field generated by the stator device 20 and the electric and/or magnetic field generated by the reaction devices 30, 40, at least partially causes movement or rotation of the disc brake member 18 and/or the wheel or rim member 14 of the vehicle, thereby at least partially propelling the vehicle.

Further, the reaction devices 30, 40 of the wheel-based propulsion system 10 of the present invention may be disposed on any one or more structures of the vehicle to facilitate propulsion of the vehicle in relation to the movement or rotation of the reaction devices 30, 40.

Moreover, the wheel-based propulsion system for a vehicle 10 of the present invention may include a sensor mechanism 50 attached and/or disposed in communicative relation to either the stator device 20, the reaction devices 30, 40, or both. Additionally, the sensor mechanism 50 may further be disposed in communicative relation with an acceleration pedal or any other button and/or switch of the vehicle. The sensor mechanism 50 may additionally be disposed in communicative relation with any portion of an engine of the vehicle, including the internal computer or any other mechanical portion.

More specifically, the sensor mechanism 50 of the present invention may be structured to be operative and/or activated/deactivated in a plurality of situations including, but not limited to, when the driver or operator of the vehicle compresses/decompresses the acceleration pedal or any other activating/deactivating button or switch, or when the vehicle is in need of additional/less power. More in particular, the sensor mechanism 50 of the present invention may be structured to increase, decrease, or maintain the electric and/or magnetic field generated or induced by the stator device 20 or the reaction device 30,40. As the electric and/or magnetic field(s) of the stator device 20 and/or the reaction device 30,40 are increased or decreased, the rotational speed or movement of the wheel-based propulsion system for a vehicle 10 of the present invention may increase or decrease, respectively.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents. Now that the invention has been described,

What is claimed is:

1. A wheel-based propulsion system for an existing vehicle comprising:
at least one stator device removably attachable and disposed in a supported relation to at least one wheel-based component of the existing vehicle, the one wheel-based component comprising a caliper housing of the vehicle,
at least one reaction device removably attachable to and movable with at least one other wheel-based component of the vehicle in a proximate relation to said stator device, said at least one reaction device associated with a reaction field,
said stator device structured to generate a stator field in interactive relation with said reaction field and at least partially causing said reaction device to rotate relative to said stator device, and
a sensor mechanism disposed in communicating relation to at least one of said stator device or said one reaction device and structured to regulate an energy supply thereto and thereby increase or decrease an intensity of said stator field or said reaction field.

2. A wheel-based propulsion system for an existing vehicle as recited in claim 1 wherein said at least one reaction device is removably attached to and rotatable with a disc brake of the vehicle.

3. A wheel-based propulsion system for an existing vehicle as recited in claim 2 further comprising a second reaction device, wherein said second reaction device is at least partially attached to at least one wheel-based component other than the disc brake in proximate relation to said stator device of the vehicle.

4. A wheel-based propulsion system for an existing vehicle as recited in claim 1 wherein said at least one reaction device is at least partially attached to a wheel of the vehicle.

5. A wheel-based propulsion system for an existing vehicle as recited in claim 1 wherein said stator field induces said reaction field in said at least one reaction device.

6. A wheel-based propulsion system for an existing vehicle as recited in claim 1 wherein said at least one reaction device is structured to generate said reaction field.

7. A wheel-based propulsion system for an existing vehicle having at least one wheel and at least one caliper housing, said wheel-based propulsion system comprising:
at least one stator device removably attached and disposed in supported relation to said at least one caliper housing of the vehicle,
at least one reaction device removably disposed in a proximate relation to said at least one stator device and associated with a reaction field,
said at least one stator device structured to generate a stator field, wherein said stator field induces said reaction field in said at least one reaction device,
said stator field and said reaction field being disposed in interactive relation to at least partially cause said at least one reaction device to rotate about an axis of the wheel, and
a sensor mechanism disposed in communicating relation with said at least one stator device and structured to regulate an energy supply thereto and thereby increase or decrease an intensity of said stator field.

8. A wheel-based propulsion system for an existing vehicle as recited in claim 7 wherein said at least one reaction device is removably attached to and rotatable with a disc brake of the vehicle.

9. A wheel-based propulsion system for an existing vehicle as recited in claim 8 further comprising a second reaction device, said second reaction device being at least partially attached to said wheel of the vehicle in proximate relation to said stator field.

10. A wheel-based propulsion system for an existing vehicle as recited in claim 7 wherein said at least one reaction device is removably attached to the wheel of the vehicle.

11. A wheel-based propulsion system for an existing vehicle having at least one wheel, a disc brake, and at least one caliper housing, said wheel-based propulsion system for a vehicle comprising:
a stator device removably attached and disposed in supported relation to the caliper housing of the vehicle,
at least one reaction device disposed in a proximate relation with said at least one stator device,
said at least one reaction device being attached to and rotatable with the disc brake of the vehicle,
said stator device structured to generate a stator field,
said at least one reaction device structured to generate a reaction field,
said stator field and said reaction field being disposed in interactive relation to one another, said interactive relation sufficient to cause rotation of said one reaction device and the disc brake relative to an axis of the wheel, and
a sensor mechanism disposed in communicating relation to at least one of said stator device or said at least one reaction device and structured to regulate an energy supply thereto and thereby increase or decrease an intensity of said stator field or said reaction field.

12. A wheel-based propulsion system for an existing vehicle as recited in claim 11 further comprising a second reaction device, wherein said second reaction device is at least partially attached to said wheel of the vehicle in proximate relation to said stator field.
